(19) United States
(12) Patent Application Publication
(10) Pub. No.: US 2014/0049134 A1
(43) Pub. Date: Feb. 20, 2014

(54) INDUCTION ELECTRICAL ROTATING MACHINE

(71) Applicants: Hidetoshi Koka, Tokyo (JP); Satoshi Kikuchi, Tokyo (JP); Yutaka Matsunobu, Hitachinaka (JP); Noriaki Hino, Tokyo (JP); Keiji Oda, Hitachinaka (JP); Yasuyuki Saito, Hitachinaka (JP); Manabu Oshida, Hitachinaka (JP); Kazuo Nishihama, Tokyo (JP)

(72) Inventors: Hidetoshi Koka, Tokyo (JP); Satoshi Kikuchi, Tokyo (JP); Yutaka Matsunobu, Hitachinaka (JP); Noriaki Hino, Tokyo (JP); Keiji Oda, Hitachinaka (JP); Yasuyuki Saito, Hitachinaka (JP); Manabu Oshida, Hitachinaka (JP); Kazuo Nishihama, Tokyo (JP)

(73) Assignee: Hitachi Automotive Systems,Ltd.

(21) Appl. No.: 14/114,297

(22) PCT Filed: May 1, 2012
(86) PCT No.: PCT/JP2012/061570

§ 371 Date: Oct. 28, 2013

(30) Foreign Application Priority Data
May 13, 2011 (JP) 2011-108234

(51) Int. Cl. H02K 17/16

(52) U.S. Cl. CPC H02K 17/165
USPC 310/211

(57) ABSTRACT

Induction electrical rotating machine includes a stator which has plural stator slots 114 formed at a predetermined spacing in a circumferential direction of a stator iron core 111 and in which a stator winding 120 is accommodated in the plural stator slots 114, and a rotor 130 in which a rotor bar 132 extending in an axial direction of the rotor iron core 111 is provided in a plural number at a spacing in a circumferential direction and in which a pair of end rings that shorts the plural rotor bars 132 at ends in the axial direction is provided. A shape of a stator-side end, of a sectional shape within a plane orthogonal to a rotor axial direction of the rotor bar 132, is asymmetrical and a notch 133 is formed.

### TECHNICAL FIELD

The present invention relates to an induction electrical rotating machine such as a motor and electrical generator.

### BACKGROUND ART

An induction electrical rotating machine for vehicle, for example, a driving motor of a hybrid electric vehicle needs to obtain a high torque from a limited battery voltage while having a constraint on the installation space on the vehicle side. Therefore, a method for raising the utilization efficiency of magnetic fluxes used for driving the induction electrical rotating machine is considered. For example, Patent Literature 1 discloses a technique in which a gap is provided on the outer diameter side, thus reducing eddy current loss generated in the bar.

### CITATION LIST

### Patent Literature

PTL 1: JP-A-8-140319

### SUMMARY OF INVENTION

### Technical Problem

By the way, at the distal end of the bar, a bar current due to a harmonic magnetic flux is generated in addition to a fundamental magnetic flux. However, in the related-art induction electrical rotating machine, the reduction in eddy current loss due to the harmonic magnetic flux is not sufficient.

### Solution to Problem

According to a first embodiment of the invention, an induction electrical rotating machine includes a stator which has plural stator slots formed at a predetermined spacing in a circumferential direction of a stator iron core and in which a stator winding is accommodated in the plural stator slots, and a rotor in which a rotor bar extending in an axial direction of a rotor iron core is provided in a plural number at a predetermined spacing in a circumferential direction and in which a pair of end rings that shorts the plural rotor bars at ends in the axial direction is provided. A shape of a stator-side end, of a sectional shape within a plane orthogonal to a rotor axial direction of the rotor bar, is asymmetrical about a radial axial line passing through a rotor axial core and an axial core of the rotor bar.

According to a second embodiment of the invention, it is preferable that, in the induction electrical rotating machine of the first embodiment, a notch is formed at a position that is at a stator-side end of the rotor bar and shifted toward a rear side of rotation with respect to the radial axial direction.

According to a third embodiment of the invention, it is preferable that, in the induction electrical rotating machine of the second embodiment, the notch is formed along an eddy current density contour line of an eddy current generated when the rotor bar has a symmetrical shape.

According to a fourth embodiment of the invention, it is preferable that, in the induction electrical rotating machine of the second embodiment, a curve sinking in an arc shape is formed as a sectional shape of the notch.

According to a fifth embodiment of the invention, it is preferable that, in the induction electrical rotating machine of the second embodiment, a sectional shape of the notch has a curvature of notch curve that is set to be smaller than a curvature on a forward side of rotation of the stator-side end with respect to the radial axial line.

According to a sixth embodiment of the invention, it is preferable that, in the induction electrical rotating machine according to one of the first to fifth embodiments, the notch is formed to extend from one axial end of the rotor bar to the other axial end.

According to a seventh embodiment of the invention, it is preferable that, in the induction electrical rotating machine according to anyone of the first to fifth embodiments, the notch is formed at a part in the axial direction of the rotor bar.

According to an eighth embodiment of the invention, it is preferable that, in the induction electrical rotating machine according to anyone of the first to fifth embodiments, a depth δ (m) of the notch is set to δ=√{2/(2πNsσμ/60)}, where is the number of stator slots, μ (H/m) is a permeability of the rotor bar, σ (S/m) is a conductivity of the rotor bar, and N (r/min) is the number of revolutions of the rotor.

According to a ninth embodiment of the invention, it is preferable that, in the induction electrical rotating machine according to any one of the first to fifth embodiments, the notch is filled with a non-magnetic and non-conductive material.

### Advantageous Effect of Invention

According to the invention, eddy current loss in the rotor bar can be restrained and improvement in the efficiency of the induction electrical rotating machine can be realized.

### BRIEF DESCRIPTION OF DRAWINGS

FIG. 1 is a block diagram showing the schematic configuration of a vehicle to which an induction electrical rotating machine of the embodiment is applied.

FIG. 2 is a view showing the configuration of an inverter unit INV.

FIG. 3 is a plan view showing an electrical rotating machine MG1 of the embodiment.

FIG. 4 is an enlarged view of a portion where a stator 110 and a rotor 130 face each other.

FIG. 5 is a view showing rotor bars 132 and end rings 134.

FIG. 6 is a view showing the current density distribution at the time of power running.

FIG. 7 is a view showing the current density distribution at the time of regenerative operation.

FIG. 8 is a view showing an example of the shape of a notch 133.

FIG. 9 is a view showing another example of the shape of the notch 133.

FIG. 10 is a view showing another example of the shape of the notch 133.

FIG. 11 is a perspective view of the rotor bar in the case where the notch is provided at a part in the extending direction.

FIG. 12 is a view showing the difference in efficiency due to the presence or absence of the notch 133.

FIG. 13 is a view showing the difference in loss due to the present or absence of the notch 133.

FIG. 14 is a view showing another shape of the rotor bar 132.

### DESCRIPTION OF EMBODIMENTS

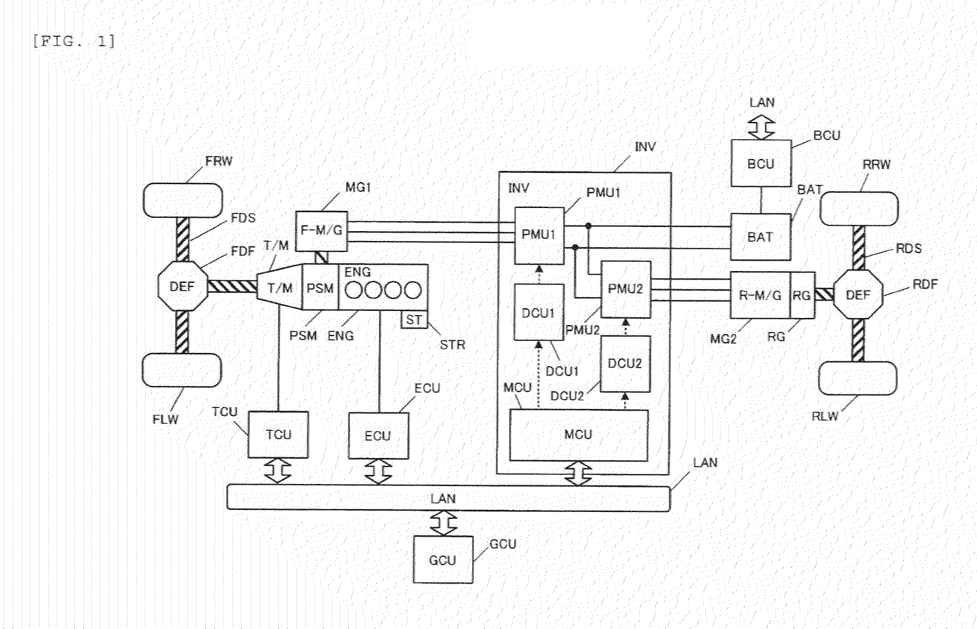

Hereinafter, an embodiment for carrying out the invention will be described with reference to the drawings. FIG. 1 is a block diagram showing the schematic configuration of a vehicle to which an induction electrical rotating machine of this embodiment is applied. Here, an example using a hybrid electric vehicle having two different driving sources will be described.

The hybrid electric vehicle in this embodiment is a four-wheel drive type configured in such a way that each of front wheels FLW, FRW is driven by an engine ENG as an internal combustion engine and an electrical rotating machine MG1 and each of rear wheels RLW, RRW is driven by an electrical rotating machine MG2. In this embodiment, the case where each of the front wheels FLW, FRW is driven by the engine ENG and the electrical rotating machine MG1 and each of the rear wheels RLW, RRW is driven by the electrical rotating machine MG2, is described. However, each of the front wheels WFLW, FRW may be driven by the electrical rotating machine MG1, and each of the rear wheels RLW, RRW may be driven by the engine ENG and the electrical rotating machine MG2.

A transmission T/M is mechanically connected to front wheel shafts FDS of the front wheels FLW, FRW via a differential unit FDF. The electrical rotating machine MG1 and the engine ENG are mechanically connected to the transmission T/M via a power distribution mechanism PSM. The power distribution mechanism PSM is a mechanism in charge of combining and distributing rotational driving forces. An AC side of an inverter unit INV is electrically connected to a stator winding of the electrical rotating machine MG1. The inverter unit INV is a power converter which converts DC power into three-phase AC power and controls the driving of the electrical rotating machine MG1. A battery BAT is electrically connected to a DC side of the inverter unit INV.

The electrical rotating machine MG2 is mechanically connected to rear wheel shafts RDS of the rear wheels RLW, RRW via a differential unit RDF and a speed reducer RG. The AC side of the inverter unit INV is electrically connected to a stator winding of the electrical rotating machine MG2. Here, the inverter unit INV is shared by the electrical rotating machines MG1, MG2 and has a power module PMU1 and a drive circuit unit DCU1 for the electrical rotating machine MG1, a power module PMU2 and a drive circuit unit DCU2 for the electrical rotating machine MG2, and a motor control unit MCU.

A starter STR is attached to the engine ENG. The starter STR is a starting unit for starting the engine ENG.

An engine control unit ECU calculates a control value for operating each component device (throttle valve, fuel injection valve and the like) of the engine ENG, based on an input signal from a sensor, another control unit or the like. This control value is outputted to a driving unit of each component device of the engine ENG as a control signal. Thus, the operation of each component device of the engine ENG is controlled.

The operation of the transmission T/M is controlled by a transmission control unit TCU. The transmission control unit TCU calculates a control value for operating the transmission mechanism, based on an input signal from a sensor, another control unit or the like. This control value is outputted to a driving unit of the transmission mechanism as a control signal. Thus, the operation of the transmission mechanism of the transmission T/M is controlled.

The battery BAT is a high-voltage lithium-ion battery with a battery voltage of 200 V or higher and has the charging/discharging and service life thereof or the like managed by a battery control unit BCU. A voltage value and a current value or the like of the battery BAT are inputted to the battery control unit BCU in order to manage the charging/discharging and service life or the like of the battery. Although not shown, a low-voltage battery with a battery voltage of 12 V is also installed as a battery and is used as a power supply for the control system and as a power supply for the radio, light and the like.

The engine control unit ECU, the transmission control unit TCU, the motor control unit MCU and the battery control unit BCU are electrically connected to each other via an onboard local area network LAN and also electrically connected to a general control unit GCU. Thus, bidirectional signal transmission is enabled between the respective control units, and mutual information communication and sharing of detection values or the like are enabled. The general control unit GCU is to output a command signal to each control unit in accordance with the operation state of the vehicle. For example, the general control unit GCU calculates a necessary torque value of the vehicle in accordance with the amount by which the accelerator is stepped down based on the acceleration request of a driver. The general control unit GCU distributes this necessary torque value into an output torque value on the side of the engine ENG and an output toque value on the side of the electrical rotating machine MG1 in such a way that the operation efficiency of the engine ENG becomes better. Moreover, the general control unit GCU outputs the distributed output torque value on the side of the engine ENG to the engine control unit ECU as an engine torque command signal, and outputs the distributed output torque value on the side of the electrical rotating machine MG1 to the motor control unit MCU as a motor torque command signal.

Next, the operation of the hybrid electric vehicle of this embodiment will be described. When the hybrid electric vehicle starts operating and at the time of low-speed traveling (a traveling zone where the operation efficiency (fuel efficiency) of the engine ENG falls), the front wheels FLW, FRW are driven by the electrical rotating machine MG1. Although the case where the front wheels FLW, FRW are driven by the electrical rotating machine MG1 when the hybrid electric vehicle starts operating and at the time of low-speed traveling is described in this example, the rear wheels RLW, RRW may be driven by the electrical rotating machine MG2 while the front wheels FLW, FRW are driven by the electrical rotating machine MG1 (four-wheel-drive traveling may be performed).

DC power is supplied to the inverter unit INV from the battery BAT. The supplied DC power is converted into three-phase AC power by the inverter unit INV. The three-phase AC power thus obtained is supplied to the stator winding of the electrical rotating machine MG1. Thus, the electrical rotating machine MG1 is driven and generates a rotation output. This rotation output is inputted to the transmission T/M via the power distribution mechanism PSM. The inputted rotation output is shifted in speed by the transmission T/M and inputted to the differential unit FDF. The inputted rotation output is distributed to the left and right by the differential unit FDF and transmitted to each of the left and right front wheel shafts FDS. Thus, the front wheel shafts FDS are rotationally driven. Then, the front wheels FLW, FRW are rotationally driven by the rotational driving of the front wheel shafts FDS.

At the time of normal traveling of the hybrid electric vehicle (a traveling zone where the operation efficiency (fuel efficiency) of the engine ENG is good, in the case where the vehicle travels on a dry road surface), the front wheels FLW, FRW are driven by the engine ENG. Therefore, the rotation output of the engine ENG is inputted to the transmission T/M via the power distribution mechanism PSM. The inputted rotation output is shifted in speed by the transmission T/M. The speed-shifted rotation output is transmitted to the front wheel shafts FDS via the differential unit FDF. Thus, the front wheels FLW, FRW are rotationally driven with WH-F.

Meanwhile, when the charging state of the battery BAT is detected and the battery BAT needs to be charged, the rotation output of the engine ENG is distributed to the electrical rotating machine MG1 via the power distribution mechanism PSM, and the electrical rotating machine MG1 is rotationally driven. Thus, the electrical rotating machine MG1 operates as an electrical generator. With this operation, three-phase AC power is generated in the stator winding of the electrical rotating machine MG1. This three-phase AC power that is generated is converted into predetermined DC power by the inverter unit INV. The DC power obtained through this conversion is supplied to the battery BAT. Thus, the battery BAT is charged.

At the time of four-wheel-drive traveling of the hybrid electric vehicle (a traveling zone where the operation efficiency (fuel efficiency) of the engine ENG is good, in the case where the vehicle travels on a low-μ road such as a snow-covered road), the rear wheels RLW, RRW are driven by the electrical rotating machine MG2. Also, similarly to the above normal traveling, the front wheels FLW, FRW are driven by the engine ENG. Moreover, since the amount of electricity stored in the battery BAT is reduced through the driving of the electrical rotating machine MG2, similarly to the above normal traveling, the electrical rotating machine MG1 is rotationally driven by the rotation output of the engine ENG, and the battery BAT is charged. In order to drive the rear wheels RLW, RRW by the electrical rotating machine MG2, DC power is supplied to the inverter unit INV from the battery BAT. The supplied DC power is converted into three-phase AC power by the inverter unit INV, and the AC power obtained through this conversion is supplied to the stator winding of the electrical rotating machine MG2. Thus, the electrical rotating machine MG2 is driven and generates a rotation output. The generated rotation output is decelerated by the speed reducer RG and inputted to the differential unit RDF. The inputted rotation output is distributed to the left and right by the differential unit RDF and transmitted to each of the left and right rear wheel shafts RDS. Thus, the rear wheel shafts RDS are rotationally driven. Then, the rear wheels RLW, RRW are rotationally driven by the rotational driving of the rear wheel shafts RDS.

When the hybrid electric vehicle accelerates, the front wheels FLW, FRW are driven by the engine ENG and the electrical rotating machine MG1. Although the case where the front wheels FLW, FRW are driven by the engine ENG and the electrical rotating machine MG1 when the hybrid electric vehicle accelerates is described in this embodiment, the rear wheels RLW, RRW may be driven by the electrical rotating machine MG2 while the front wheels FLW, FRW are driven by the engine ENG and the electrical rotating machine MG1 (four-wheel-drive traveling may be performed). The rotation output of the engine ENG and the electrical rotating machine MG1 is inputted to the transmission T/M via the power distribution mechanism PSM. The inputted rotation output is shifted in speed by the transmission TIM. The speed-shifted rotation output is transmitted to the front wheel shafts FDS via the differential unit FDF. Thus, the front wheels FLW, FRW are rotationally driven.

When the hybrid electric vehicle performs regenerative operation (at the time of deceleration such as when the brake is stepped on, when the stepping on the accelerator is loosened, or when the stepping on the accelerator is stopped), the rotational force of the front wheels FLW, FRW is transmitted to the electrical rotating machine MG1 via the front wheel shafts FDS, the differential unit FDF, the transmission T/M and the power distribution mechanism PSM, and the electrical rotating machine MG1 is rotationally driven. Thus, the electrical rotating machine MG1 operates as an electrical generator. With this operation, three-phase AC power is generated in the stator winding of the electrical rotating machine MG1. This three-phase AC power that is generated is converted into predetermined DC power by the inverter unit INV. The DC power obtained through this conversion is supplied to the battery BAT. Thus, the battery BAT is charged.

Meanwhile, the rotational force of the rear wheels RLW, RRW is transmitted to the electrical rotating machine MG2 via the rear wheel shafts RDS, the differential unit RDF and the speed reducer RG, and the electrical rotating machine MG2 is rotationally driven. Thus, the electrical rotating machine MG2 operates as an electrical generator. With this operation, three-phase AC power is generated in the stator winding of the electrical rotating machine MG2. This three-phase AC power that is generated is converted into predetermined DC power by the inverter unit INV. The DC power obtained through this conversion is supplied to the battery BAT. Thus, the battery BAT is charged.

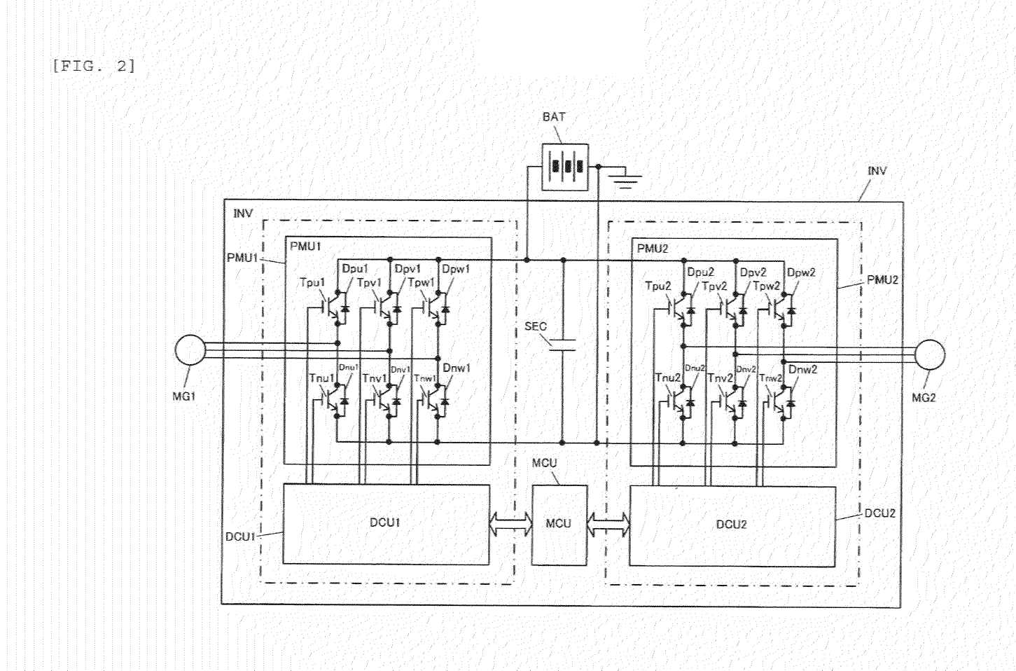

FIG. 2 shows the configuration of the inverter unit INV in this embodiment. The inverter unit INV includes the power modules PMU1, PMU2, the drive circuit units DCU1, DCU2, and the motor control unit MCU, as described above. The power modules PMU1, PMU2 have the same configuration. The drive circuit units DCU1, DCU2 have the same configuration.

The power module PMU1, PMU2 forms a conversion circuit (also referred to as a main circuit) that converts DC power supplied from the battery BAT into AC power and supplies the AC power to the corresponding electrical rotating machine MG1, MG2. Also, the conversion circuit can convert AC power supplied from the corresponding electrical rotating machine MG1, MG2 and supply the DC power to the battery BAT.

The conversion circuit is a bridge circuit, in which series circuits corresponding to three phases are electrically connected in parallel between the positive electrode side and the negative electrode side of the battery BAT. A series circuit is also called an arm and includes two semiconductor elements.

In the arm, a power semiconductor element on an upper arm side and a power semiconductor element on a lower arm side are electrically connected in series for each phase. In this embodiment, an IGBT (insulated-gate bipolar transistor) that is a switching semiconductor element is used as a power semiconductor element. A semiconductor chip forming the IGBT has three electrodes, that is, a collector electrode, an emitter electrode, and a gate electrode. Between the collector electrode and the emitter electrode of the IGBT, a diode of another chip than the IGBT is electrically connected. The diode is electrically connected between the emitter electrode and the collector electrode of the IGBT in such a way that the direction from the emitter electrode toward the collector electrode of the IGBT is the forward direction. Also, in some cases, a MOSFET (metal-oxide semiconductor field-effect transistor) is used as a power semiconductor element in stead of the IGBT. In such cases, the diode is omitted.

The emitter electrode of a power semiconductor element Tpu1 and the collector electrode of a power semiconductor element Tnu1 are electrically connected in series, thus forming a U-phase arm of the power module PMU1. A V-phase arm and a W-phase arm are formed similarly to the U-phase arm. The emitter electrode of a power semiconductor element Tpv1 and the collector electrode of a power semiconductor element Tnv1 are electrically connected in series, thus forming the V-phase arm of the power module PMU1. The emitter electrode of a power semiconductor element Tpw1 and the collector electrode of a power semiconductor element Tnw1 are electrically connected in series, thus forming the W-phase arm of the power module PMU1. In the power module PMU2, too, the arms of the respective phases are formed in the connecting relations similar to the above power module PMU1.

The collector electrodes of the power semiconductor elements Tpu1, Tpv1, Tpw1, Tpu2, Tpv2, Tpw2 are electrically connected to the high-potential side (positive electrode side) of the battery BAT. The emitter electrodes of the power semiconductor elements Tnu1, Tnv1, Tnw1, Tnu2, Tnv2, Tnw2 are electrically connected to the low-potential side (negative electrode side) of the battery BAT.

The middle point in the U-phase arm (V-phase arm, W-phase arm) of the power module PMU1 (the connecting part between the emitter electrode of the upper arm-side power semiconductor element and the collector electrode of the lower arm-side power semiconductor element in each arm) is electrically connected to the U-phase (V-phase, W-phase) stator winding of the electrical rotating machine MG1.

The middle point in the U-phase arm (V-phase arm, W-phase arm) of the power module PMU2 (the connecting part between the emitter electrode of the upper arm-side power semiconductor element and the collector electrode of the lower arm-side power semiconductor element in each arm) is electrically connected to the U-phase (V-phase, W-phase) stator winding of the electrical rotating machine MG2.

Between the positive electrode side and the negative electrode side of the battery BAT, a smoothing electrolytic capacitor SEC is electrically connected in order to control fluctuations in DC voltage generated by the operation of the power semiconductor elements.

The drive circuit unit DCU1, DCU2 forms a driving unit that outputs a drive signal causing each power semiconductor element in the power modules PMU1, PMU2 to operate based on a control signal outputted from the motor control unit MCU and thus causes each power semiconductor element to operate, and includes circuit components such as an insulated power supply, an interface circuit, a driving circuit, a sensor circuit, and a snubber circuit (none of them shown).

The motor control unit MCU is an arithmetic unit including a microcomputer, and inputs plural input signals and outputs a control signal for causing each power semiconductor element in the power modules PMU1, PMU2 to operate, to the drive circuit units DCU1, DCU2. As input signals, torque command values τ*1, τ*2, current detection signals iu1 to iw1, iu2 to iw2, and magnetic pole position detection signals θ1, θ2 are inputted.

The torque command values τ*1, τ*2 are outputted from an upper-order control unit in accordance with the operation mode of the vehicle. The torque command value τ*1 corresponds to the electrical rotating machine MG1 and the torque command value τ*2 corresponds to the electrical rotating machine MG2. The current detection signals iu1 to iw1 are detection signals of u-phase to w-phase input currents supplied to the stator windings of the electrical rotating machine MG1 from the conversion circuit of the inverter unit INV and detected by a current sensor such as a current transformer (CT). The current detection signals iu2 to iw2 are detection signals of u-phase to w-phase input currents supplied to the stator windings of the electrical rotating machine MG2 from the inverter unit INV and detected by a current sensor such as a current transformer (CT).

The magnetic pole position detection signal θ1 is a detection signal of the magnetic pole position of rotation of the electrical rotating machine MG1 and detected by a magnetic pole position sensor such as a resolver, encoder, Hall element or Hall IC. The magnetic pole position detection signal θ2 is a detection signal of the magnetic pole position of rotation of the electrical rotating machine MG1 and detected by a magnetic pole position sensor such as a resolver, encoder, Hall element or Hall IC.

The motor control unit MCU calculates a voltage control value based on the input signals and outputs this voltage control value to the drive circuit units DCU1, DCU2 as a control signal (PWM signal (pulse width modulation signal)) for causing the power semiconductor elements Tpu1 to Tnw1, Tpu2 to Tnw2 in the power modules PMU1, PMU2 to operate.

Generally, the PWM signal outputted from the motor control unit MCU has a time-average voltage in the form of a sine wave. In this case, the instantaneous maximum output voltage is the voltage on the DC line that is the input of the inverter. Therefore, when the sine-wave voltage is outputted, the effective value thereof is 1/√2. Thus, in the hybrid electric vehicle in this embodiment, the effective value of the input voltage of the motor is increased in order to raise the output of the motor further with the limited inverter unit. That is, the PWM signal from the MCU is made to have only ON and OFF in the form of a rectangular wave. Thus, the peak value of the rectangular wave is the voltage Vdc on the DC line of the inverter and the effective value thereof is Vdc. This is a method for maximizing the voltage effective value.

However, the rectangular-wave voltage has a problem that the current waveform is disturbed because inductance is small in a low-rotation-number zone. Therefore, an unwanted exciting force is generated in the motor and noise occurs. Thus, rectangular-wave voltage control is used only at the time of high-speed rotation, whereas normal PWM control is carried out at the time of low frequencies.

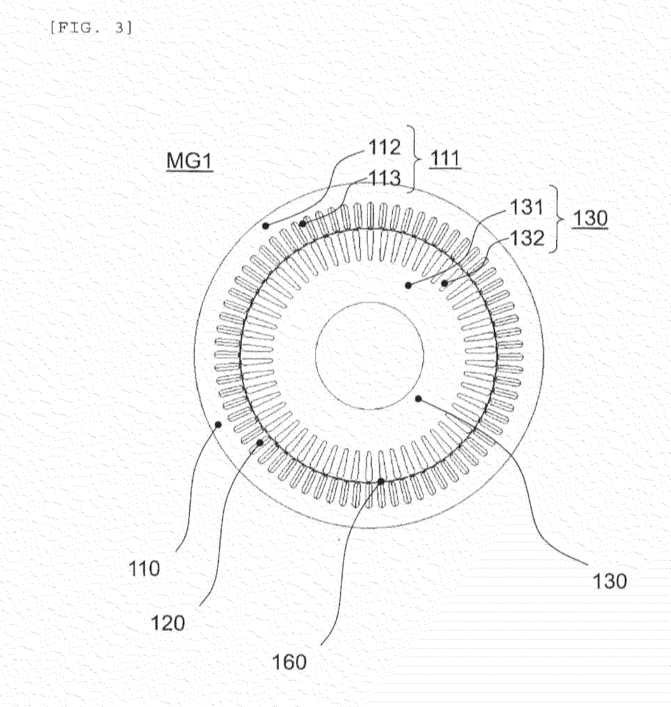

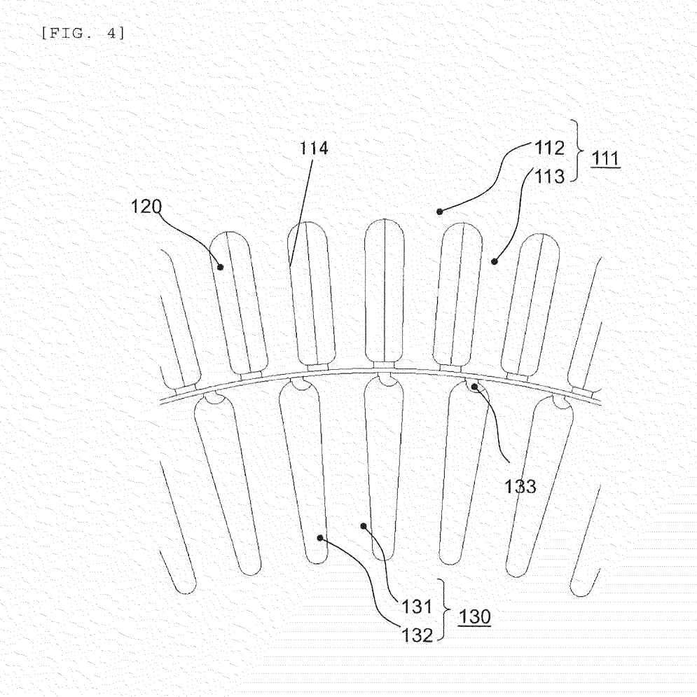

FIG. 3 is a plan view showing the electrical rotating machine MG1 of this embodiment. FIG. 4 is a view showing, in an enlarged manner, a portion where a stator 110 and a rotor 130 of FIG. 3 face each other. The same components are denoted by the same reference numerals. While the configuration of the electrical rotating machine MG1 is described hereinafter, the electrical rotating machine MG2 has a similar configuration.

The electrical rotating machine MG1 has the stator 110 which generates a rotating magnetic field, and the rotor 130 which is rotatably arranged on the inner circumferential side of the stator 110 via a gap 160 and is rotated by a magnetic action with the stator 110. The stator 110 has a stator core 111 made up of a core back 112 and teeth 113, and slots 114 in which a stator winding 120 generating a magnetic field through electrification is inserted.

The stator core 111 includes plural plate-like molded members stacked in an axial direction, the plate-like molded members being punched out of a plate-like magnetic member. Alternatively, the stator core 111 may be made of cast iron. Here, the axial direction refers to the direction along the rotation axis of the rotor 130. The stator winding 120 is inserted in the slots 114 and thus arranged in the state of being wound on the teeth 113.

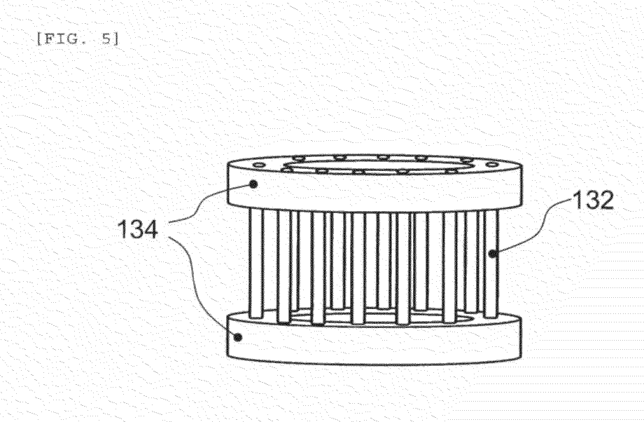

The rotor 130 has a rotor core 131 forming a magnetic path on the rotating side, rotor bars 132 made of anon-magnetic and conductive metal such as aluminum or copper, and a shaft (not shown) serving as a rotation axis. The rotor bars 132 extend in the axial direction of the rotor 130, and end rings 134 for shorting the rotor bars 132 at the ends in the axial direction, as shown in FIG. 5. A notch 133 is formed on the outer diameter side of the rotor bars 132 (stator-side end area). As the notch 133 is provided on the rotor bars 132, the efficiency of the electrical rotating machine MG1 can be improved, as described later.

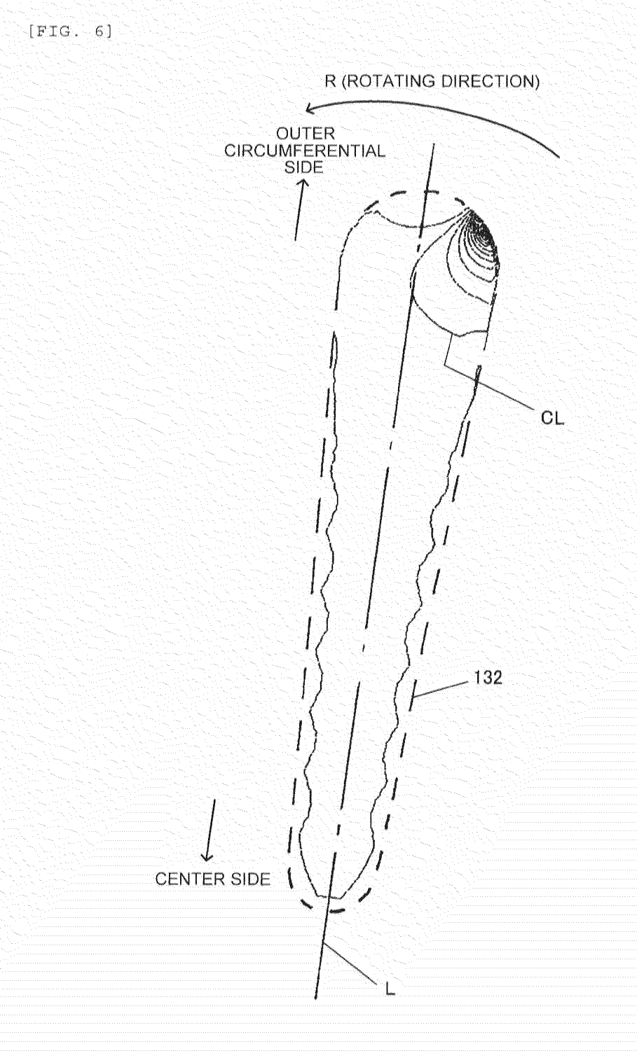

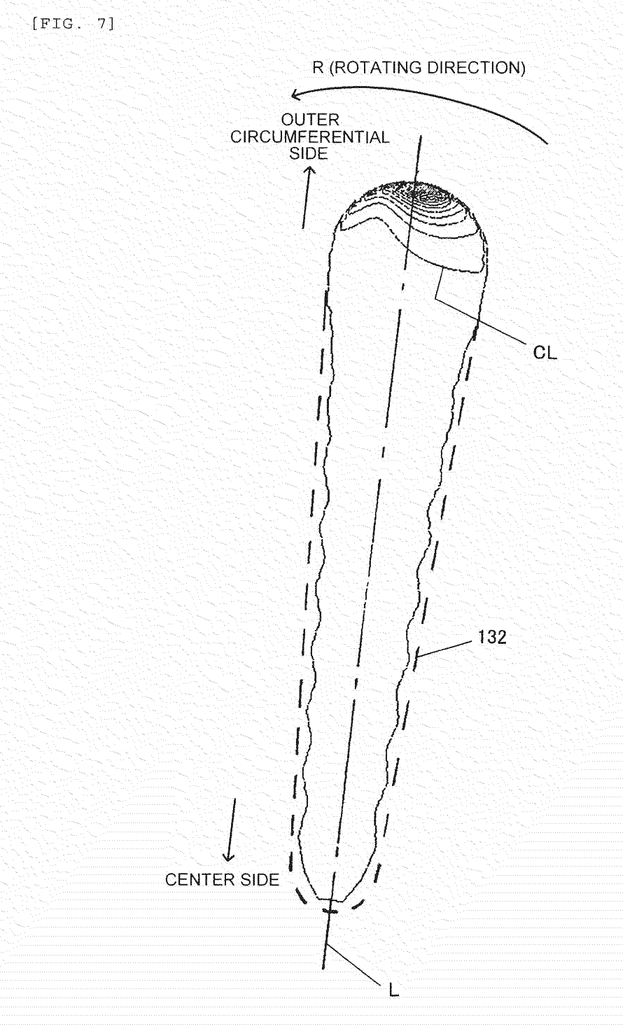

FIGS. 6 and 7 show the results of an analysis of the current density distribution generated in the rotor bar 132, using a finite element method. Both figures show the case where the notch 133 is not provided, that is, the case where the sectional shape of the rotor bar 132 is symmetrical about an axial line L. FIG. 6 shows the current density distribution at the time of power running. FIG. 7 shows the current density distribution at the time of regenerative operation. The axial line L is a radial straight line passing through the axial core of the rotor 130 and the axial core of the rotor bar 132. Broken lines show the sectional shape of the rotor bar 132. Solid lines show the contour lines of current density. An arrow R shows the rotating direction of the rotor. By the way, the rotating direction here refers to the main rotating direction (forward rotation) in the case where the electrical rotating machine is used. For the electrical rotating machine installed in a vehicle, the rotating direction in the case of moving the vehicle forward is the main rotating direction.

Since the slots 114 are formed in the stator core 111, magnetic resistance differs between the part of the slots 114 and the part of the teeth 113. Therefore, the magnetic density of magnetic fluxes interlinked with the rotor bars 132 changes greatly between the case where the rotor bars 132 rotating with the rotor 130 are situated near the teeth and the case where the rotor bars are situated near the slots. Generally, this is called slot harmonics. As a result, a current (eddy current) flows through the rotor bars 132 in such a way as to cancel the change in the magnetic fluxes. This current is generated on the rotor outer circumferential side of the rotor bars 132. This can be understood from the current density that is higher on the outer circumferential side of the rotor bar 132, as shown in FIGS. 6 and 7. However, this current is a current accompanying the slot harmonics and does not contribute to the torque.

By the way, if the results of the analysis of FIGS. 6 and 7 are examined in detail, it is understood that the eddy current due to the slot harmonics concentrates on the rear side of rotation with respect to the axial line L of the rotor bar 132. Based on this, it is desirable to provide the notch 133 in a shape including an area on the rear side in the rotating direction where the eddy current concentrates, in order to reduce eddy current loss effectively while satisfying the torque. If the notch 133 is not provided, the rotor bar 132 is left-right symmetric and the axial core of the rotor bar 132 exists on the axis of symmetry. That is, in this embodiment, since the notch 133 is formed on the rear side of rotation, the sectional shape of the rotor bar 132 is left-right a symmetric.

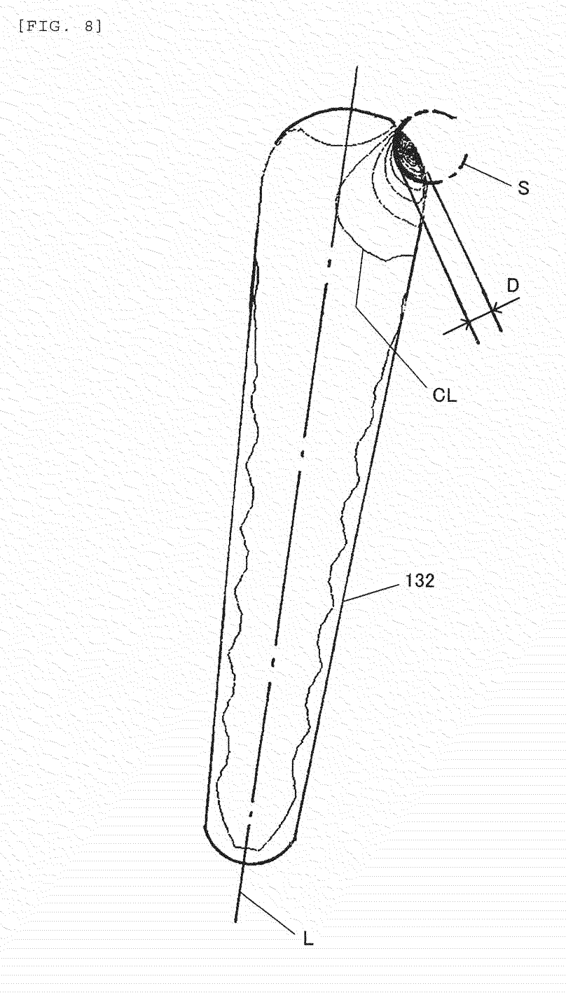

FIGS. 6 and 7 show the current density distribution at a certain moment. The distribution slightly changes depending on the rotation angle position of the rotor 130. However, on average, the distribution can be considered to be substantially the same as the distributions of FIGS. 6 and 7. Therefore, as the shape of the notch 133, it is preferable to cut out a shape following the contour lines CL of current density obtained through the analysis, such as a curve indicated by the reference symbol S in FIG. 8. In this case, the shape of the notch line S formed in an outer circumferential end area of the rotor bar 132 is a curve sinking substantially in an arc shape and the position thereof (the position of the central part of the notch 133) is shifted toward the rear side of rotation with respect to the axial line L. The depth of the notch 133 and the amount of shift toward the rear side of rotation from the axial line L may be decided based on the foregoing results of the current density analysis.

It is preferable to set the depth D of the notch 133 according to the depth of distribution where harmonic eddy current loss is generated. Since the depth of magnetic flux permeation δ in the rotor bar 132 is expressed by the following equation (1), the depth may be set such as D≧δ. Here, ω is the frequency of the magnetic flux [rad/s], σ is the conductivity of the bar [S/m], and μ is bar permeability [H/m]. The frequency ω of the magnetic flux is expressed by ω=2πNs/60, where N [r/min] is the number of revolutions of the rotor and is the number of stator slots.

δ=√{2/(ωσμ)} (1)

For example, if the number of revolutions that is often used is 6000 r/min and the number of stator slots is 72, ω=2×π×6000/60×72=45239 rad/s results. If aluminum is used for the rotor bar 132, σ=3.2×107 S/m and μ=4×π×10−7=1.257×10−6 H/m hold and therefore the depth of magnetic flux permeability δ in this case is 1.05 mm.

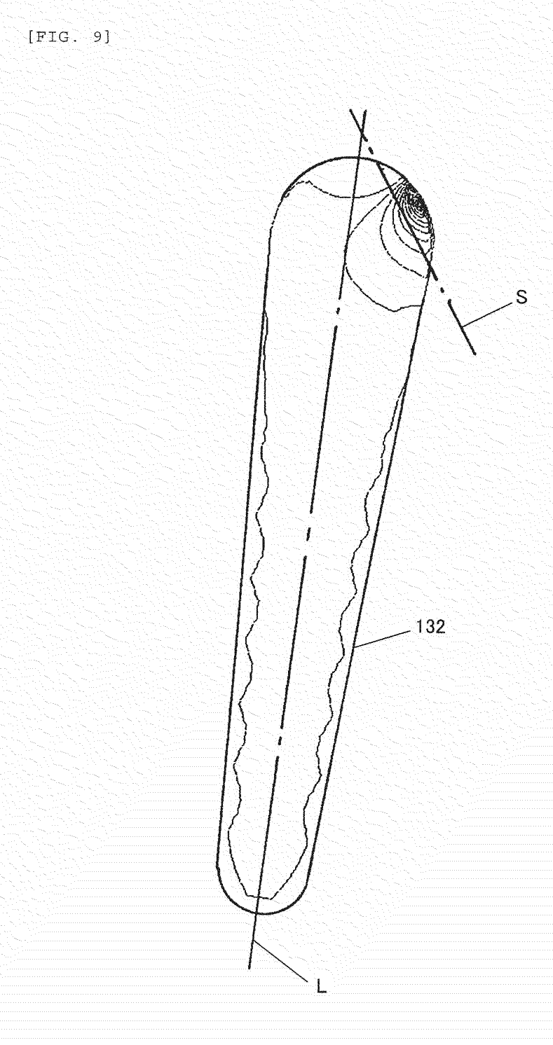

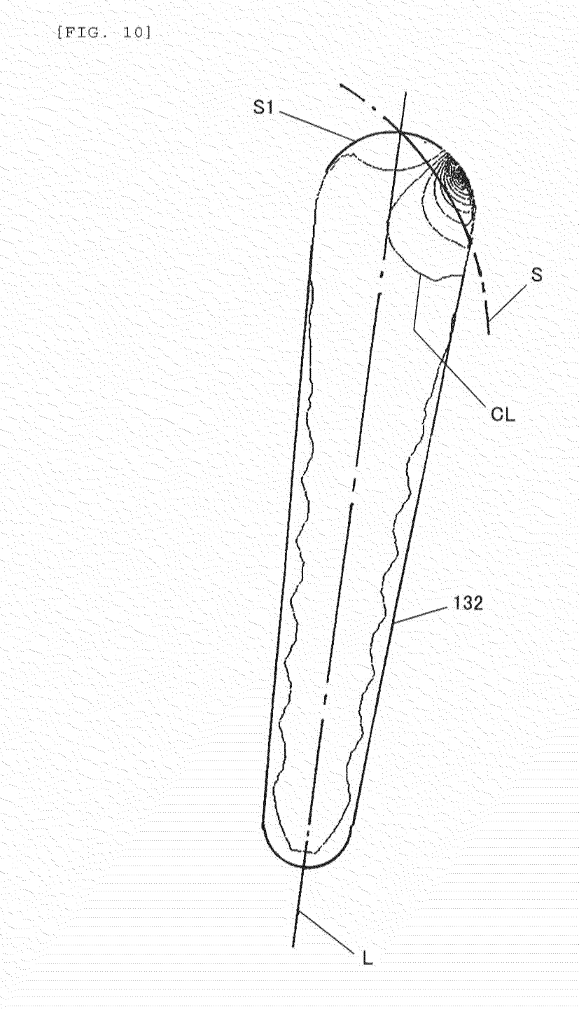

Meanwhile, if the width of a portion called a bridge between the bar distal end and the air gap is narrowed by moving the rotor bar 132 toward the rotor outer circumferential surface, asymmetry of the current density distribution about the axial line L increases. Therefore, it is desirable to consider the place of the notch 133 accordingly. In the example shown in FIG. 4, a semicircular notch 133 is provided. However, considering the ease in processing, notch shapes as shown in FIGS. 9 and 10 may be formed. FIG. 9 shows the case where the notch line S is a straight line. In FIG. 10, the notch line S is convex outward and the curvature thereof is smaller than the curvature of a distal end S1 on the left side (forward side of rotation) of the axial line L. In both cases, since the area where the current density concentrates is cut out, eddy current loss due to slot harmonics can be reduced.

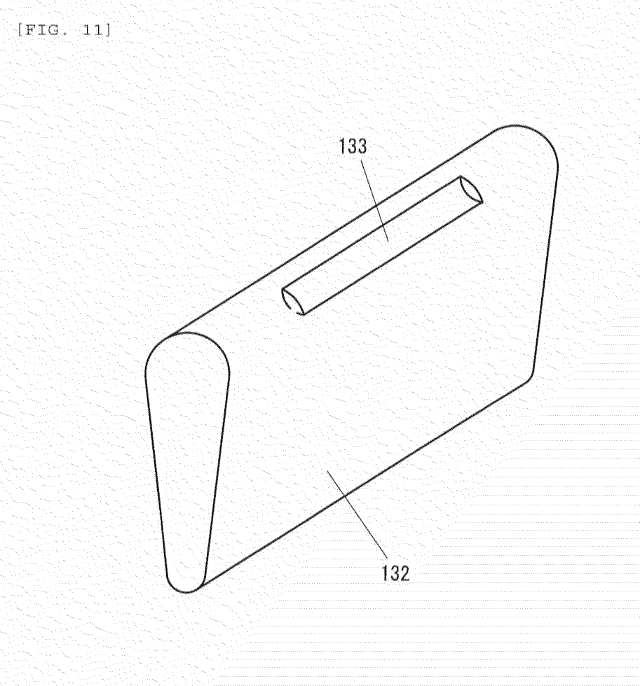

While the notch 133 is formed from one end to the other end along the extending direction of the rotor bar 132 in this embodiment, the notch may be formed at a part in the axial direction, as shown in FIG. 11.

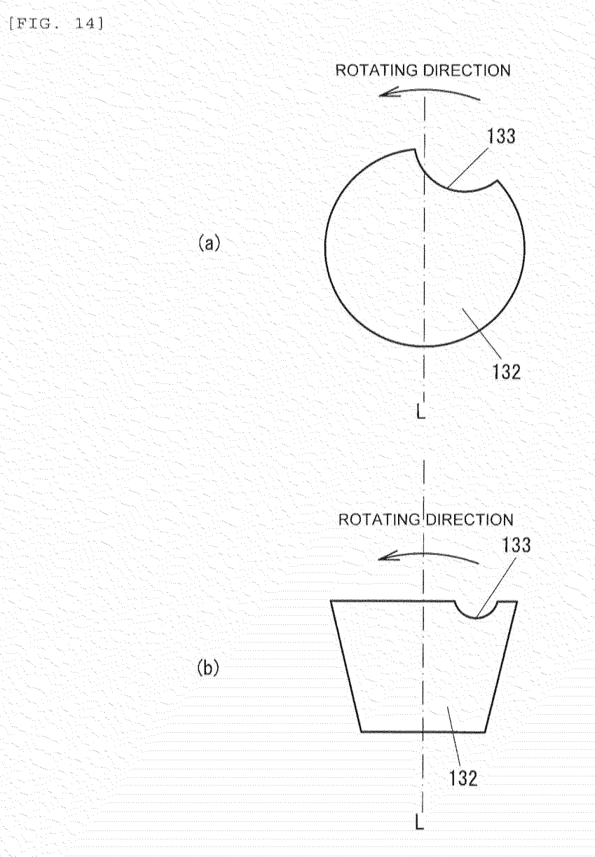

Also, the sectional shape of the rotor bar 132 is not limited to the shape shown in FIG. 4, and rotor bars 132 with shapes as shown in FIGS. 14(a) and 14(b) can be similarly applied. FIG. 14(a) shows a rotor bar 132 having a circular sectional shape, with a notch 133 formed therein. FIG. 14(b) shows a rotor bar 132 having a trapezoidal sectional shape, with a notch 133 formed therein. In both cases, the notch 133 is formed with a shift toward the rear side of rotation with respect to the axial line L, at the stator-side end.

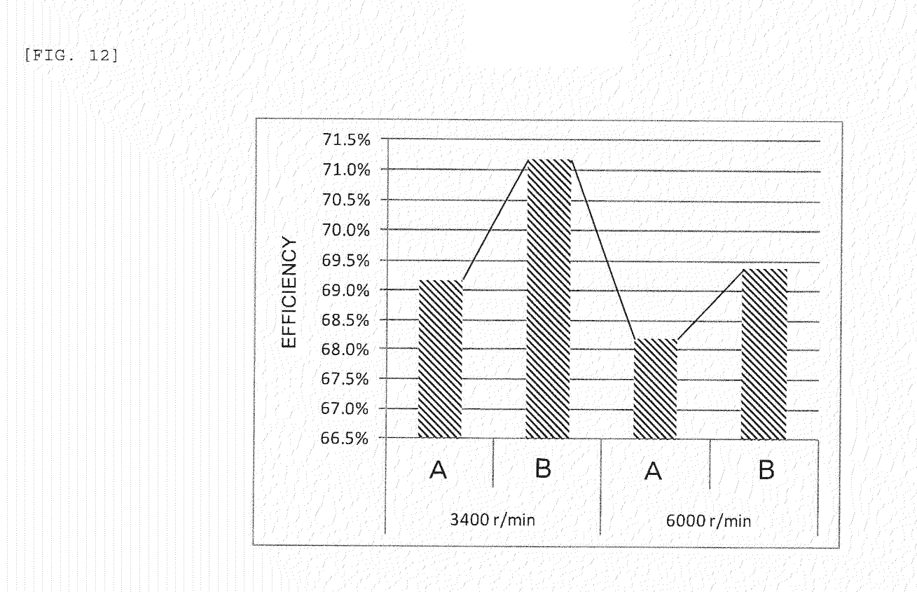

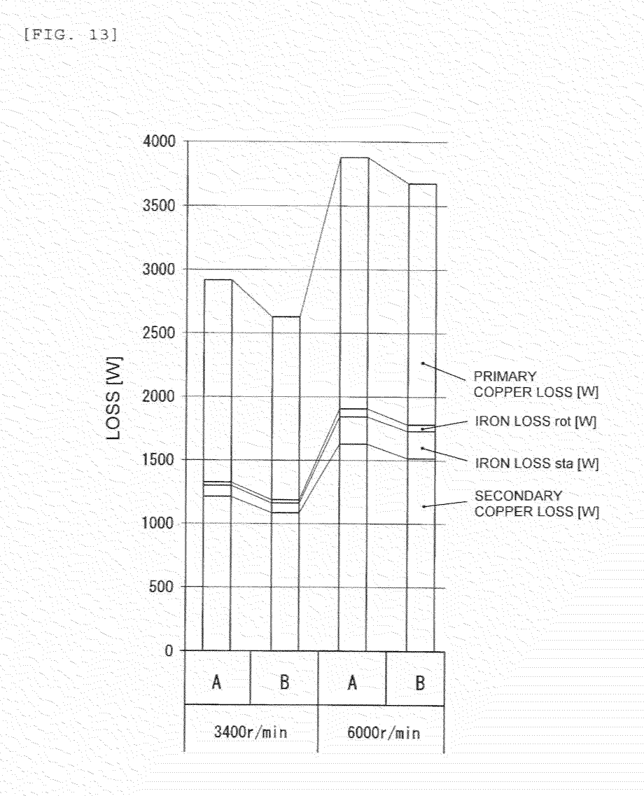

In FIGS. 12 and 13, details of efficiency and loss are calculated using a finite element method, with respect to each of a case A where a rotor bar 132 having a conventional shape without a notch 133 and a case B where a rotor bar 132 provided with a notch 133. As calculation conditions, the number of revolutions is 3400 r/min (18.5 Nm) and 6000 r/min (13.0 Nm) on the assumption that the JC08 mode is used.

FIG. 12 shows the efficiency under each condition. With both of the numbers of revolutions 3400 r/min and 6000 r/min, the efficiency is higher in the case B where the notch 133 is provided. FIG. 13 shows details of loss in each case. The loss due to the above eddy current generated in the rotor bar 132 is included in the loss called secondary copper loss. According to FIG. 13, the secondary copper loss is reduced by providing the notch 133 in the rotor bar 132.

By the way, it is possible to reduce the secondary copper loss simply by moving the rotor bar 132 toward the center of the rotor. However, this technique is not desirable because of a drawback that the magnetic flux interlinked with the rotor bar 132 is reduced, thus reducing the torque. Meanwhile, by arranging the rotor bar 132 toward the rotor outer circumferential side as in this embodiment and providing the notch 133 as described above, both the torque and the loss can be satisfied. It is also understood that since the torque can be achieved by a small current, primary copper loss is reduced, too.

Also, for example, a motor for hybrid electric vehicle is required to be smaller-sized in order to be installed in the engine room. By using the electrical rotating machine of this embodiment, it is possible to improve the torque, compared with an electrical rotating machine having a constitution of the same size. That is, according to the invention, the motor constitution can be reduced in size.

In the above embodiment, the gap (the gap including the notch 133) is provided at the distal end of the rotor bar. However, the gap may be filled with a material mainly of resin or silicon as long as the material is non-magnetic and non-conductive. If the rotor bar 132 is joined to the end ring 134 by welding or punching in, the gap may be left vacant. However, if the rotor bar 132 and the end ring 134 are formed by die casting, it is desirable that the die casting is carried out in the state where the notch 133 at the distal end of the rotor bar is filled with a non-magnetic and non-conductive material.

As described above, according to the embodiment, eddy current loss can be reduced and the torque can be improved. In each of the above examples, the inner rotor-type electrical rotating machine is used as an example in the explanation. However, the invention can also be applied to an outer rotor-type electrical rotating machine. The above respective embodiments can be used singly or in combination. This is because the effects of each embodiment can be achieved singly or in combination. Also, the invention is not limited to the above examples as long as the characteristics of the invention are not impaired.

The disclosed content of the following application as a basis of priority claim is incorporated herein by reference.

Japanese Patent Application No. 2011-108234 (filed on May 13, 2011)

1-9. (canceled)

10. An induction electrical rotating machine comprising:
a stator which has plural stator slots formed at a predetermined spacing in a circumferential direction of a stator iron core and in which a stator winding is accommodated in the plural stator slots; and
a rotor in which a rotor bar extending in an axial direction of the rotor iron core is provided in a plural number at a predetermined spacing in a circumferential direction and in which a pair of end rings that shorts the plural rotor bars at ends in the axial direction is provided;
wherein a notch is formed at a position that is at a stator-side end of the rotor bar and shifted toward a rear side of rotation with respect to the radial axial direction
in such a way that a shape of a stator-side end, of a sectional shape within a plane orthogonal to a rotor axial direction of the rotor bar, becomes asymmetrical about a radial axial line passing through a rotor axial core and an axial core of the rotor bar.

11. The induction electrical rotating machine according to claim 10,
wherein the notch is formed along an eddy current density contour line of an eddy current generated when the rotor bar has a symmetrical shape.

12. The induction electrical rotating machine according to claim 10,
wherein a curve sinking in an arc shape is formed as a sectional shape of the notch.

13. The induction electrical rotating machine according to claim 10,
wherein a sectional shape of the notch has a curvature of notch curve that is set to be smaller than a curvature on a forward side of rotation of the stator-side end with respect to the radial axial line.

14. The induction electrical rotating machine according to claim 10,
wherein the notch is formed to extend from one axial end of the rotor bar to the other axial end.

15. The induction electrical rotating machine according to claim 10,
wherein the notch is formed at a part in the axial direction of the rotor bar.

16. The induction electrical rotating machine according to claim 10,
wherein a depth δ (m) of the notch is set to δ=√{2/(2πNsσμ/60)}, where s is the number of the stator slots, μ (H/m) is a permeability of the rotor bar, σ (S/m) is a conductivity of the rotor bar, and N (r/min) is the number of revolutions of the rotor.

17. The induction electrical rotating machine according to claim 10,
wherein the notch is filled with a non-magnetic and non-conductive material.
